(19) United States
(12) Patent Application Publication
(10) Pub. No.: US 2016/0339478 A1
(43) Pub. Date: Nov. 24, 2016

(54) DRY-TYPE CLEANING MACHINE

(71) Applicant: KUN SHENG MACHINE CO., LTD., Taichung City (TW)

(72) Inventor: CHUN-YU TSAI, Taichung City (TW)

(21) Appl. No.: 14/714,908

(22) Filed: May 18, 2015

(51) Int. Cl. B07B 4/08; B07B 9/00

(52) U.S. Cl. CPC B07B 4/08; B07B 9/00

(57) ABSTRACT

A dry-type cleaning machine includes a negative pressure unit, a first dust gathering unit having a first dust sucking passage communicated with the negative pressure unit, and a barrel body. The barrel body has a receiving space communicated with the first dust sucking passage, a feeding inlet for a material to be sieved, a discharging portion, a rotary assembly in the receiving space, and a sieve layer. The material to be sieved includes crushed aggregates and dirt. The sieve layer is between the rotary assembly and the first dust sucking passage. The rotary assembly is for stirring the material to be sieved. The feeding inlet, the first dust sucking passage and the receiving space form a negative pressure passage. The sieve layer allows the dirt to pass through and enter the first dust sucking passage. The crushed aggregates are discharged out of the receiving space.

### BACKGROUND OF THE INVENTION

1. Field of the Invention

The present invention relates to a cleaning machine, and more particularly to a dry-type cleaning machine.

2. Description of the Prior Art

Usually, in a process of recycling waste materials (for example, plastic, rubber or cloth), the waste materials are put in a crusher to be crushed, and then a cutter stirs and cuts the waste materials with a liquid as an auxiliary so as to wash away dirt on the waste materials. Therefore, crushed aggregates after the crushing process are cleaner. This type of cleaning machines are disclosed in TW237695, TWM409934 and TWM411293.

However, with the conventional cleaning machine, a clean liquid is essential during a process of cleaning the waste materials, so it is water-wasting and costly to use the conventional cleaning machine to clean the waste materials. Besides, the liquid used to clean the waste materials is dirty, so the liquid used needs to be processed before being discharged. In addition, the liquid used may leak out of the cleaning machine and make the work environment dirty, and if the liquid used is not processed before being discharged, the liquid used may pollute the environment.

The present invention has arisen to mitigate and/or obviate the afore-described disadvantages.

### SUMMARY OF THE INVENTION

The major object of the present invention is to provide a dry-type cleaning machine. On the premise of being environment-friendly, a cleaning machine in which no liquid is needed is designed to save water and cost. In addition, dirt is gathered via a negative pressure system to prevent air and water pollution and to create a better work environment.

To achieve the above and other objects, a dry-type cleaning machine is provided, including a negative pressure unit, a first dust gathering unit and a barrel body. The first dust gathering unit is formed with a first dust sucking passage communicated with the negative pressure unit. The barrel body has a receiving space communicated with the first dust sucking passage, a feeding inlet for entering of an material to be sieved, a discharging portion, a rotary assembly arranged in the receiving space and a sieve layer. The material to be sieved includes mixed crushed aggregates and dirt. The sieve layer is arranged between the rotary assembly and the first dust sucking passage, and the rotary assembly is driven by a power source to stir the material to be sieved continuously. The feeding inlet is communicated with the first dust sucking passage through the receiving space and the sieve layer to form a negative pressure passage. The sieve layer allows the dirt to pass therethrough and enter the first dust sucking passage, and the crushed aggregates pass through the discharging portion and are discharged out of the receiving space.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a partial breakdown drawing of a first preferred embodiment of the present invention;

FIG. 2 is a partial perspective drawing of the first preferred embodiment of the present invention;

FIG. 3 is a side view of the first preferred embodiment of the present invention;

FIG. 4 is another side view of the first preferred embodiment of the present invention;

FIG. 5 is still another side view of the first preferred embodiment of the present invention;

FIG. 6 is a perspective drawing of a second dust gathering unit of the first preferred embodiment of the present invention;

FIGS. 7 and 8 are drawings showing a second preferred embodiment of the present invention;

FIG. 9 is a side view of a third preferred embodiment of the present invention; and

FIG. 10 is another side view of the third preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

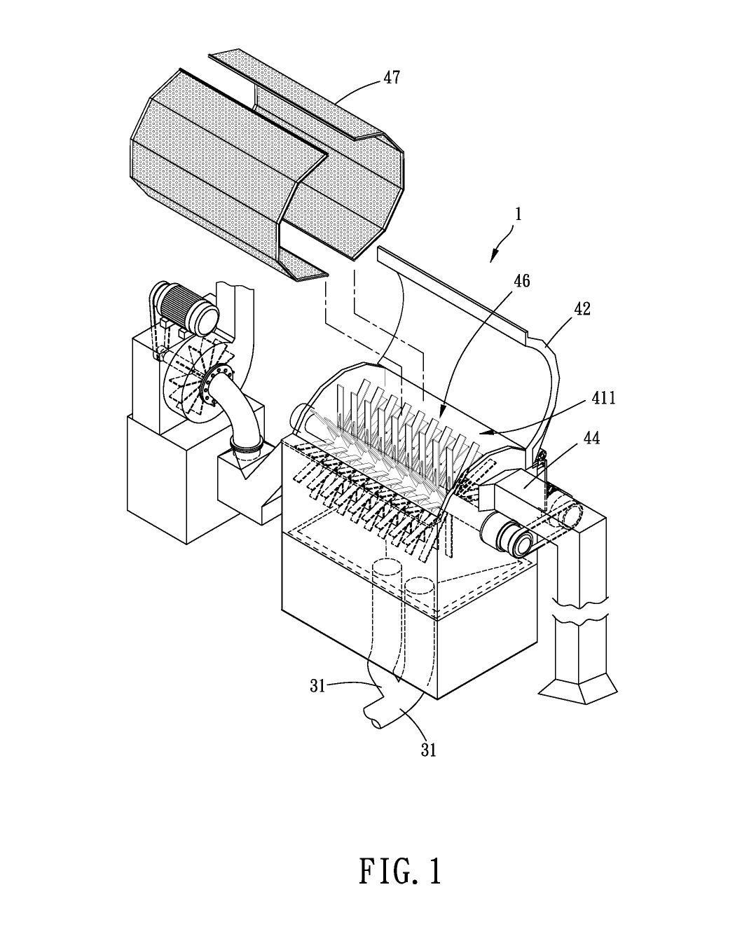

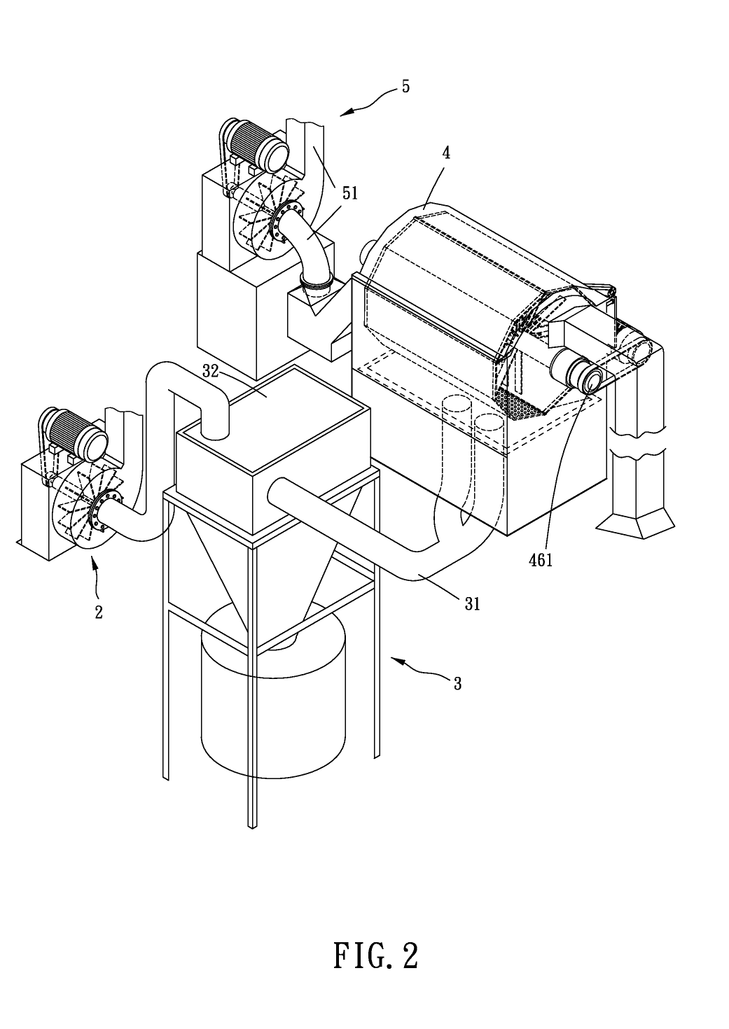

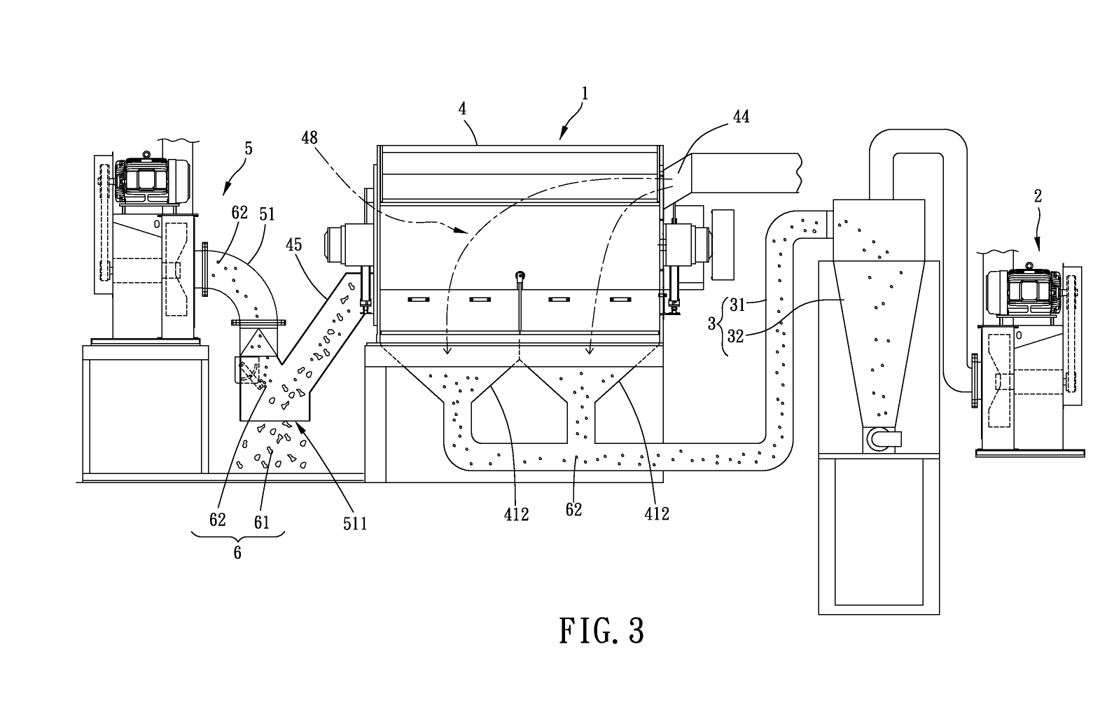

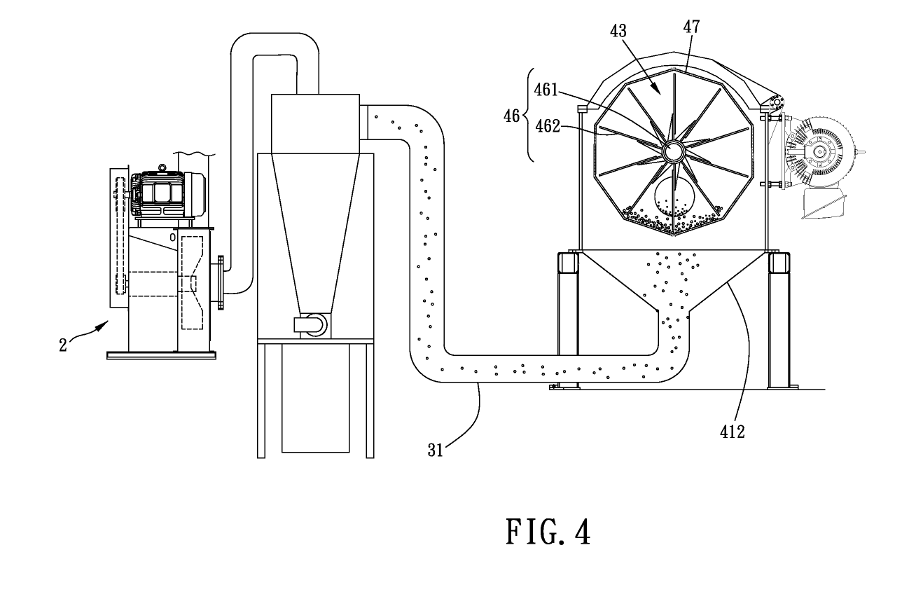

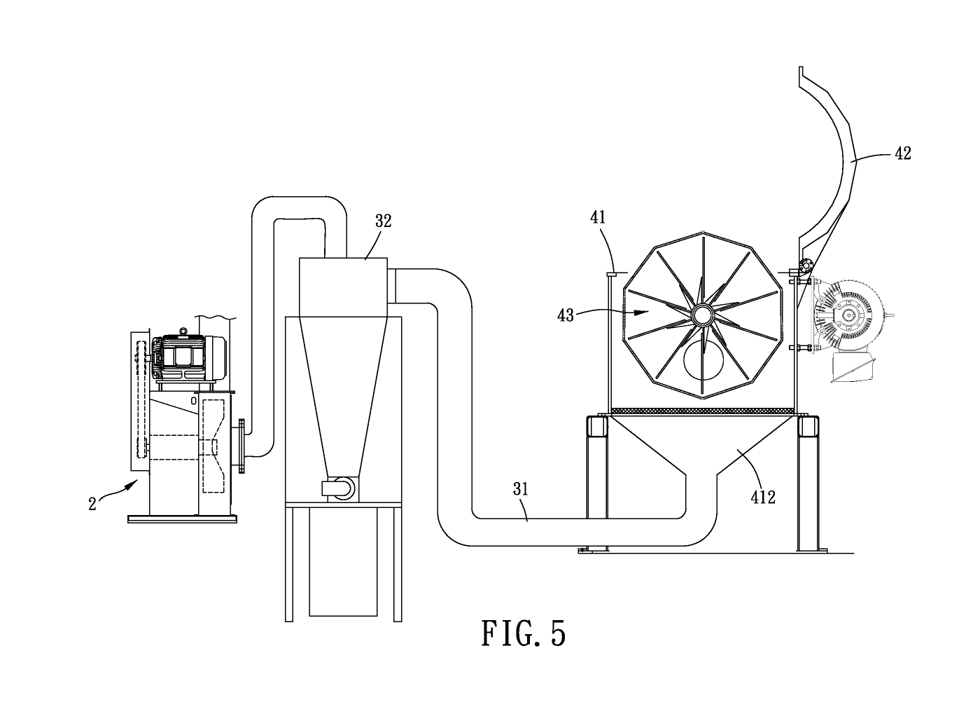

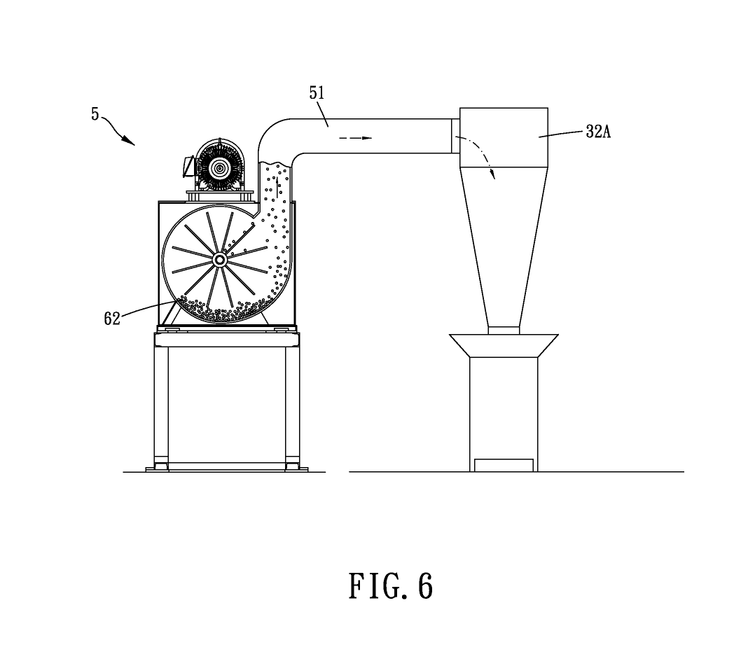

Please refer to FIGS. 1 to 6 for a first preferred embodiment of a dry-type cleaning machine 1 of the present invention. The dry-type cleaning machine 1 includes a negative pressure unit 2, a first dust gathering unit 3 and a barrel body 4. The first dust gathering unit 3 is formed with a first dust sucking passage 31 communicated with the negative pressure unit 2. The barrel body 4 has a receiving space 43 communicated with the first dust sucking passage 31, a feeding inlet 44 for entering of an material to be sieved 6, a discharging portion 45, a rotary assembly 46 arranged in the receiving space 43 and a sieve layer 47. The material to be sieved 6 includes mixed crushed aggregates 61 (for example, crushed plastics) and dirt 62 (for example, soil or dust). The sieve layer 47 is arranged between the rotary assembly 46 and the first dust sucking passage 31, and the rotary assembly 46 is driven by a power source to stir the material to be sieved 6 continuously. The feeding inlet 44 is communicated with the first dust sucking passage 31 through the receiving space 43 and the sieve layer 47 to form a negative pressure passage 48.

The sieve layer 47 allows the dirt 62 to pass therethrough and enter the first dust sucking passage 31, and the crushed aggregates 61 pass through the discharging portion 45 and are discharged out of the receiving space 43.

Specifically, the barrel body 4 is communicated with the negative pressure unit 2, so there is a pressure difference between the receiving space 43 and outside.

The pressure difference allows an opening of the feeding inlet 44 to produce a sucking force inward. That is, the feeding inlet 44, the receiving space 43 and the sieve layer 47 form the negative pressure passage 48 to suck the dirt 62 through negative pressure so as to prevent the dirt 62 from polluting surroundings. In the receiving space 43, the material to be sieved 6 is stirred and rolled continuously by the rotary assembly 46, so the dirt 62 and the crushed aggregates 61 are separated. Because each sieve aperture of the sieve layer 47 has a fixed and predetermined radial dimension, the dirt 62 in smaller radial dimension can pass through the sieve layer 47 and be sucked into the first dust sucking passage 31.

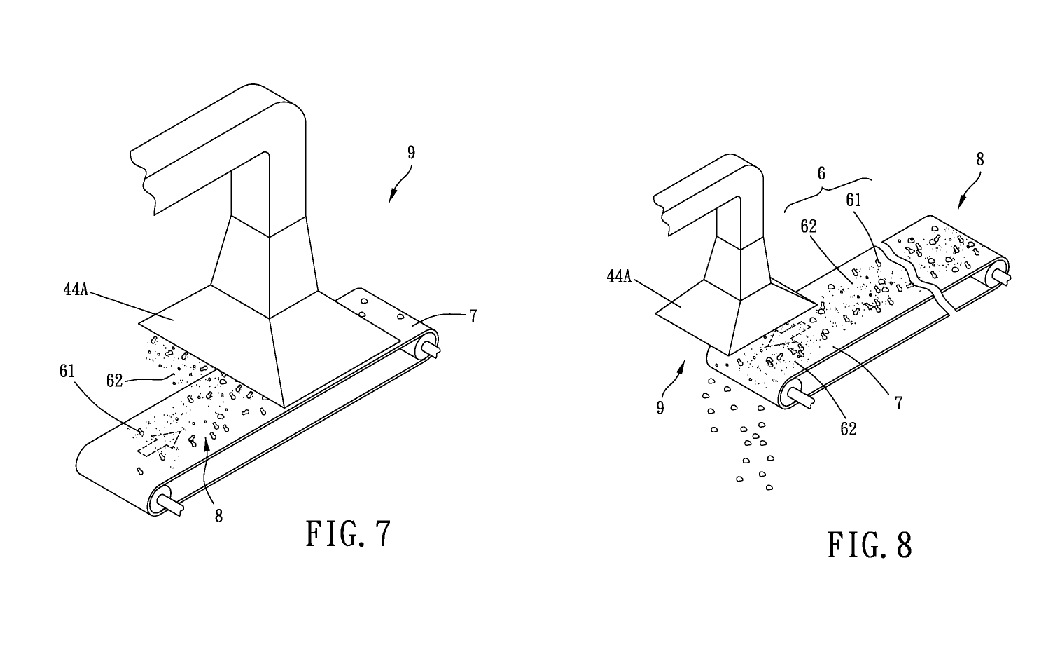

Please refer to FIGS. 7 and 8 for a second preferred embodiment of the present invention, further including a delivery platform 7 for delivering mixed materials 8. The mixed materials 8 at least include the material to be sieved 6. The feeding inlet 44A is near the delivery platform 7 for sucking the material to be sieved 6, and the feeding inlet 44A and the delivery platform 7 form a suction-selecting unit 9. Specifically, the delivery platform 7 may be connected with a crusher (not shown) to carry the mixed materials 8 (for example, metals, stones, crushed aggregates 61, dirt 62 and others) discharged from the crusher. Wherein, an opening of the feeding inlet 44A may be arranged above the delivery platform 7, and the crushed aggregates 61 and the dirt 62 delivered by the delivery platform 7 can be separated from the mixed materials 8 via the feeding inlet 44A and then be sucked into the negative pressure passage 48 to be cleaned; or the opening of the feeding inlet 44A may be arranged at a distal end of the delivery platform 7, heavier materials in the mixed materials 8 (for example, stones or metals) fall directly due to gravity, and the crushed aggregates 61 and the dirt 62 can be sucked into the negative pressure passage 48 through the feeding inlet 44A. In other embodiments, the delivery platform 7 may deliver all the mixed materials 8 through the feeding inlet 44A and into an interior of the barrel body 4.

Please further refer to FIGS. 1 to 6 for the first embodiment, the rotary assembly 46 has a rotary shaft 461 axially disposed in the barrel body 4 and a plurality of blades 462 radially extending from the rotary shaft 461. When the rotary assembly 46 rotates, the blades 462 can not only stir the material to be sieved 6 but also knock the material to be sieved 6 to make a volume of the dirt 62 smaller so as allow the dirt 62 to pass the sieve layer 47 and be sucked into the first dust sucking passage 31 more easily. Wherein, the sieve layer 47 is arranged above the barrel body 4 and around the rotary assembly 46 circumferentially to prevent the material to be sieved 6 in larger volumes from being sucked into the first dust sucking passage 31 and blocking the first dust sucking passage 31. In addition, the barrel body 4 of this embodiment further includes a main body 41 and a lid 42. A circumferential side of the main body is formed with an opening 411, and the lid 42 is openably and closably connected with the main body 41 to cover or uncover the opening 411. Therefore, it is convenient to maintain the barrel body 4 or to replace damaged elements in the barrel body 4.

Because the material to be sieved 6 is influenced by gravity and negative pressure suction, the material to be sieved 6 accumulates in a lower portion of the receiving space 43. Preferably, an extension direction of the barrel body 4 is parallel to a ground on which the dry-type cleaning machine 1 is set, the lower portion of the receiving space 43 has greater space to carry the material to be sieved 6, a circumferential side of the barrel body 4 facing the ground on which the dry-type cleaning machine 1 is set extends downward to form at least one gathering portion 412, each gathering portion 412 is substantially funnel-shaped, the first dust sucking passage 31 is connected with each gathering portion 412, and each funnel-shaped gathering portion 412 allows the dirt 62 to roll into the first dust sucking passage 31 and prevents the dirt 62 from blocking the first dust sucking passage 31. In this embodiment, the barrel body 4 has two the gathering portions 412, and the two gathering portions 412 are communicated with the negative pressure unit 2 through the first dust sucking passage 31 respectively. It is understandable that one of the gathering portions 412 may be communicated with another said negative pressure unit 2 to increase the force of negative pressure suction. Preferably, the first dust gathering unit 3 is further formed with a dust gathering barrel 32 which is communicated with the first dust sucking passage 31 and the negative pressure unit 2. The dirt 62 which passes through the sieve layer 47 and enters the first dust sucking passage 31 can be kept in the dust gathering barrel 32, so the dirt 62 can be processed solely and prevented from influencing functioning of the negative pressure unit 2.

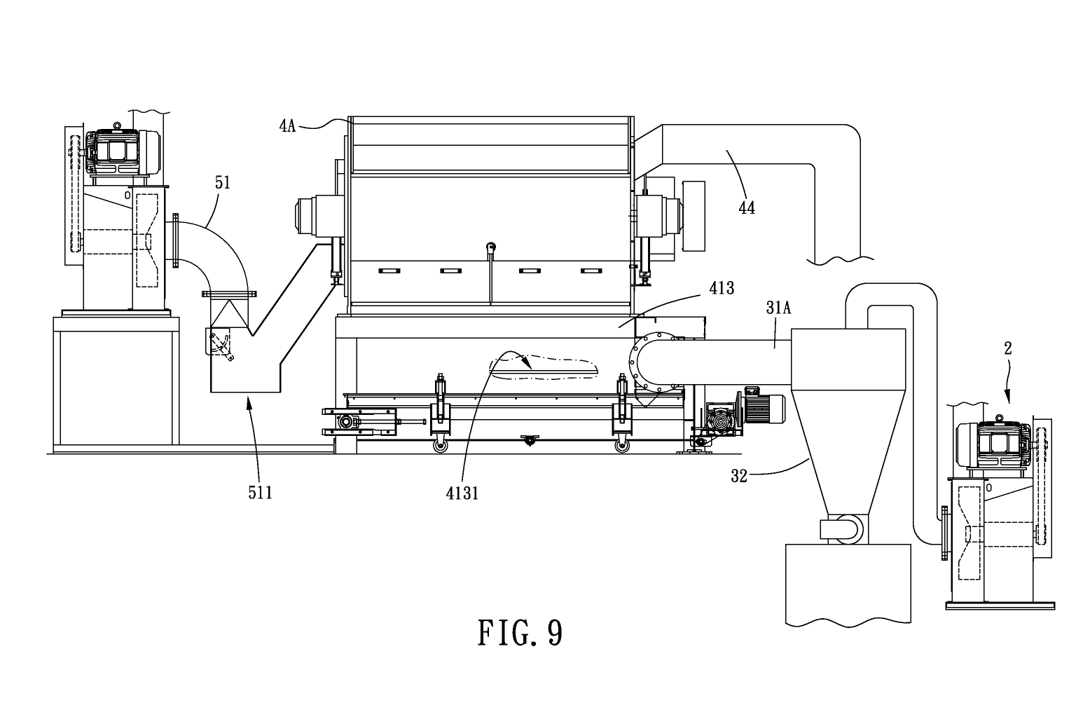

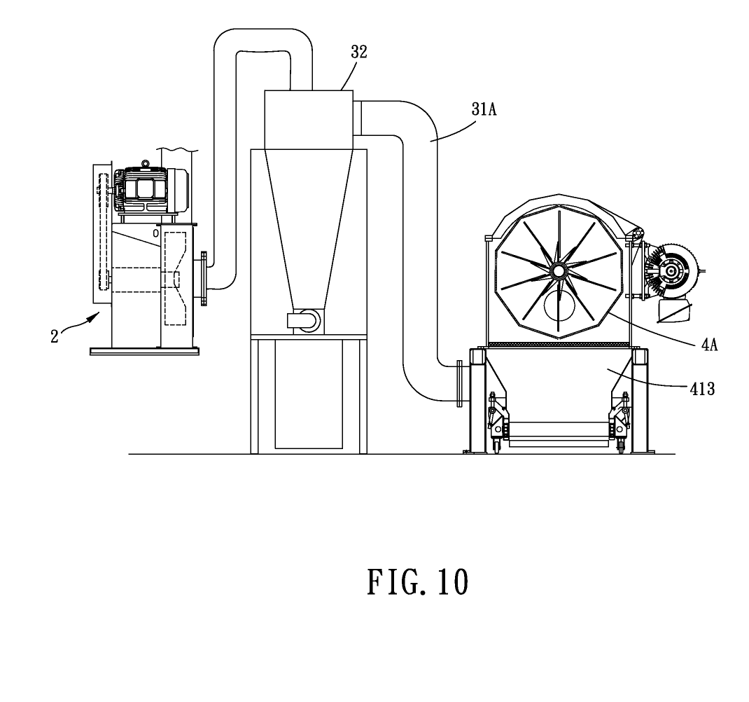

However, a connection of the barrel body 4 and the first dust sucking passage 31 is not limited. Please further refer to FIGS. 9 and 10 for a barrel body 4A and a first dust sucking passage 31A of a third preferred embodiment. A circumferential side of the barrel body 4 facing the ground on which the dry-type cleaning machine 1 is set is further formed with a carrying portion 413, and an interior of the carrying portion 413 is communicated with the receiving space 43 and the first dust sucking passage 31A. The sieve layer 47 is arranged between the rotary assembly 46 and the carrying portion 413. When the dirt 62 passes through the sieve layer 47 and enters the carrying portion 413, a part of the dirt 62 which is lighter is sucked into the first dust sucking passage 31A directly, and a part of the dirt 62 which is heavier accumulates in the carrying portion 413. Preferably, the carrying portion 413 is separable from the barrel body 4A, and the carrying portion 413 is formed with rollers so that the carrying portion 413 can be moved to a dirt processing plant directly. Or, the interior of the carrying portion 413 may be formed with a delivery assembly 4131 for delivering the dirt 62 to deliver the dirt 62 toward the first dust sucking passage 31A.

Please refer to FIGS. 1 to 6 for the first embodiment. When the crushed aggregates 61 are guided out through the discharging portion 45, there is still a part of dirt 62 in the crushed aggregates 61. The dry-type cleaning machine 1, preferably, further includes a second dust gathering unit 5, and the second dust gathering unit 5 has a second dust sucking passage 51 communicated with the discharging portion 45; wherein the crushed aggregates 61 and the part of the dirt 62 are guided out of the receiving space 43 through the discharging portion 45 and enter the second dust sucking passage 51, the second dust gathering unit 5 is provided for sucking the part of dirt 62 which is lighter to sieve the crushed aggregates 61 again and to separate the crushed aggregates 61 and the part of dirt 62 which is lighter from each other, the second dust sucking passage 51 is formed with a feeding outlet 511 facing downward, and the feeding outlet 511 is provided for the crushed aggregates 61 to be guided through the second dust sucking passage 51 and out of the feeding outlet 511 due to gravity. It is understandable that the second dust gathering unit 5 may be formed with another said dust gathering barrel 32A to store the dirt 62 which has been sieved for the second time.

Given the above, the dry-type cleaning machine use negative pressure to create pressure difference between the receiving space of the barrel body and outside so as to suck the material to be sieved into the receiving space accurately. If the dry-type cleaning machine is assembled to a discharging opening of a crusher, the dirt in the material to be sieved can be prevented from polluting the surroundings.

In addition, each fan leaf of the rotary assembly is a blade, and the blades stir the material to be sieved to separate the dirt from the crushed aggregates and make the dirt smaller to be sucked into the first dust sucking passage. The dirt is gathered in the dust gathering barrel.

In addition, the feeding inlet may further cooperate with a delivery platform to form a suction-selecting unit to sieve out the material to be sieved from the mixed materials and to suck the material to be sieved into the negative pressure passage. A bottom portion of the barrel body may be funnel-shaped to keep the dirt rolling and to prevent the dirt from accumulating on the sieve layer. Furthermore, the bottom portion of the barrel body may be further formed with the carrying portion for carrying the dirt which is heavier.

While we have shown and described various embodiments in accordance with the present invention, it should be clear to those skilled in the art that further embodiments may be made without departing from the scope of the present invention.

What is claimed is:

1. A dry-type cleaning machine, including:
a negative pressure unit;
a first dust gathering unit, having a first dust sucking passage communicated with the negative pressure unit;
a barrel body, having a receiving space communicated with the first dust sucking passage, a feeding inlet for entering of a material to be sieved, a discharging portion, a rotary assembly arranged in the receiving space and a sieve layer, the material to be sieved including crushed aggregates and dirt, the sieve layer arranged between the rotary assembly and the first dust sucking passage, the rotary assembly driven by a power source to stir the material to be sieved continuously, the feeding inlet communicated with the first dust sucking passage through the receiving space and the sieve layer to form a negative pressure passage, the sieve layer allowing the dirt to pass therethrough and enter the first dust sucking passage, the crushed aggregates passing through the discharging portion and being discharged out of the receiving space.

2. The dry-type cleaning machine of claim 1, wherein the first dust gathering unit further has a dust gathering barrel, and the dust gathering barrel is communicated with the first dust sucking passage and the negative pressure unit.

3. The dry-type cleaning machine of claim 1, further including a second dust gathering unit, the second dust gathering unit having a second dust sucking passage communicated with the discharging portion, wherein the crushed aggregates along with a part of the dirt in the receiving space are discharged out of the discharging portion and enter the second dust sucking passage, and the second dust gathering unit is provided for sucking the part of the dirt.

4. The dry-type cleaning machine of claim 3, wherein the second dust sucking passage is formed with a feeding outlet which faces downward, and the feeding outlet is provided for discharging the crushed aggregates out of the second dust sucking passage.

5. The dry-type cleaning machine of claim 1, wherein the barrel body further includes a main body and a lid, a circumferential side of the main body is formed with an opening, and the lid is openably and closably connected with the main body to cover or uncover the opening.

6. The dry-type cleaning machine of claim 1, wherein an extension direction of the barrel body is parallel to a ground on which the dry-type cleaning machine is set, a circumferential side of the barrel body facing the ground on which the dry-type cleaning machine is set extends downward to form at least one gathering portion, each gathering portion is substantially funnel-shaped, and the first dust sucking passage is connected with each gathering portion.

7. The dry-type cleaning machine of claim 1, wherein a circumferential side of the barrel body facing a ground on which the dry-type cleaning machine is set is further formed with a carrying portion, an interior of the carrying portion is communicated with the receiving space and the first dust sucking passage, and the sieve layer is disposed between the rotary assembly and the carrying portion.

8. The dry-type cleaning machine of claim 7, wherein the interior of the carrying portion is formed with a delivery assembly for delivering the dirt.

9. The dry-type cleaning machine of claim 1, wherein the rotary assembly has a rotary shaft which is axially disposed in the barrel body and a plurality of blades radially extending from the rotary shaft.

10. The dry-type cleaning machine of claim 1, further including a delivery platform for delivering mixed materials, the mixed materials at least including the material to be sieved, the feeding inlet being disposed in a position near the delivery platform for sucking the material to be sieved, the feeding inlet and the delivery platform forming a suction-selecting unit.
